(19) United States
(12) Patent Application Publication
(10) Pub. No.: US 2024/0122338 A1
(43) Pub. Date: Apr. 18, 2024

(54) SHELF WITH LIGHTING EFFECT

(71) Applicant: Ching-Hui CHEN, Huizhou (CN)

(72) Inventor: Ching-Hui CHEN, Huizhou (CN)

(21) Appl. No.: 17/992,948

(22) Filed: Nov. 23, 2022

(30) Foreign Application Priority Data
Oct. 18, 2022 (CN) 202222743426.9

(51) Int. Cl. A47B 47/00; F21S 4/28; F21V 23/00; F21V 23/02; F21V 23/04; F21V 23/06

(52) U.S. Cl. CPC A47B 47/0083; F21S 4/28; F21V 23/002; F21V 23/023; F21V 23/04; F21V 23/06; A47B 2220/0077

(57) ABSTRACT

The present utility model discloses a shelf with lighting effect, which vertically spaces a plurality of mounting frames, connects them respectively among a plurality of upright columns; the said mounting frames are installed with support plates to form a vertical shelf with a plurality of compartments, each of which can be used to hold objects; on the side of the mounting frames is arranged with at least one lamp groove, and in the lamp grooves are arranged with LED light strips electrically connected with the power supply subassembly to provide lighting effect for the objects placed on the support plates.

### BACKGROUND OF THE INVENTION

The present utility model relates to the technical field of shelves, in particular to a shelf with lighting effect.

The shelves are widely used in shopping malls, supermarkets, warehouses, warehouses, offices and homes. In recent years, the assembled shelves have become increasingly popular along with the continuous development of standardized production technologies and the continuous increase in transportation costs. The assembled shelves are in an unassembled state after production and during transportation; in this case, the space occupied by the assembled shelves is relatively small, and such shelves after be packaged generally take on standard cubes, particularly useful for significantly reducing the transportation costs of the assembled shelves. However, the existing assembled shelves still have many defects. To be specific, for example, some shelves used in families are mostly used to hold objects for exhibition decoration; however, at night, the light is insufficient, the shelves themselves are not equipped with light sources for lighting the objects; therefore, it is possible for people to collide with the shelves when walking and make the shelves and the objects placed on the shelves fall to the ground and thus cause breakage or damage to the shelves and/or objects and finally cause losses. In addition, the shelves are not equipped with light sources for lighting, and thus the decoration effect is poor.

### BRIEF SUMMARY OF THE INVENTION

The main purpose of the present utility model is to provide a shelf with lighting effect, which aims to increase the lighting effect for the shelf, and avoid the losses of objects caused by collision with the shelf when the light is insufficient as well as avoid the poor decorative effect of the shelf.

In order to realize the above purpose, the present utility model provides a shelf with lighting effect comprising a plurality of upright columns and a plurality of mounting frames with support plates, wherein the said mounting frames are vertically spaced and connected respectively among the said upright columns, on the side of the said mounting frames is arranged with at least one lamp groove, and in the lamp grooves are arranged with LED light strips electrically connected with the power supply subassembly.

A technical solution of the present utility model vertically spaces a plurality of mounting frames, connects them respectively among a plurality of upright columns; the said mounting frames are installed with support plates to form a vertical shelf with a plurality of compartments, each of which can be used to hold objects; on the side of the mounting frames is arranged with at least one lamp groove, and in the lamp groove is arranged with an LED light strip electrically connected with the power supply subassembly to provide lighting effect for the objects placed on the support plates; certainly, users also can choose not to place objects on the shelf but use the shelf as a lamp decoration. Compared with conventional shelves, the shelf in the present utility model is arranged with an LED light strip to provide lighting effect for the objects placed on the support plates and thus effectively prevent people from colliding with the shelf due to insufficient light when walking at night; meanwhile, the LED light strip can improve the decorative effect of the shelf; the overall structure of the shelf is simple and thus the installation and removal of the shelf is very convenient.

### BRIEF DESCRIPTION OF THE DRAWINGS

FIG. 1 is a perspective view of the present utility model;

FIG. 2 is a perspective view of a mounting frame;

FIG. 3 is a sectional and perspective view of a mounting frame;

FIG. 4 is a coordination diagram of a corner code, a power base and a LED light strip;

FIG. 5 is a perspective view of a corner block;

FIG. 6 is a perspective view of a tubular member;

FIG. 7 is a perspective view of a light transmitting cover;

FIG. 8 is a perspective view of the power cord.

### DETAILED DESCRIPTION OF THE INVENTION

The technical solutions of the present utility model will be described more clearly and fully in conjunction with the accompanying drawings of the present utility model, and obviously, the described embodiments are merely a part of the embodiments of the present utility model, not all the embodiments. Based on the embodiments of the present utility model, all the other embodiments obtained by the ordinary skilled in the art without creative labors belong to the scope claimed by the present utility model.

It should be noted that if an embodiment of the present utility model relates to directive instructions (such as upper, lower, left, right, front, rear, top, bottom, inside, outside, vertical, transverse, longitudinal, counter-clockwise, clockwise, circumferential, radial and axial), these directive instructions are merely used to explain the relative position relationship, the movement and so on among the components at certain specific posture (as shown in the accompanying drawings); if the specific posture changes, the directive instructions should be changed accordingly.

In addition, if an embodiment of the present utility model relates to the descriptions such as “first” and “second”, these descriptions are merely used for description and should not be understood to indicate or imply their relative importance or implicitly indicate the number of the corresponding technical features. This shows that the features limited with “first” and “second” can explicitly or implicitly include one such feature at least. Moreover, the technical solutions among the embodiments can be in combination with each other; however, such combination must be on the premise that those skilled in the art can realize the related technical solutions; when the technical solutions are inconsistent or cannot be realized, such combination of technical solutions should be deemed to be inexistent and not in the scope claimed by the present utility model.

The present utility model provides a shelf with lighting effect.

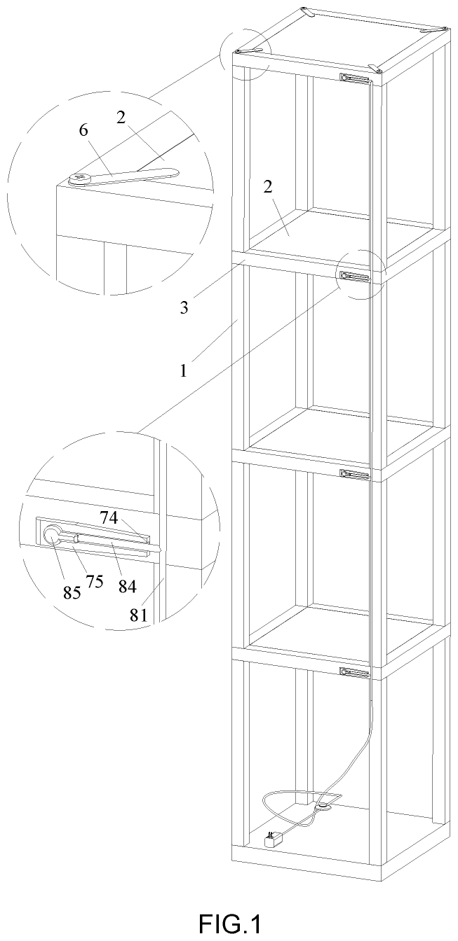

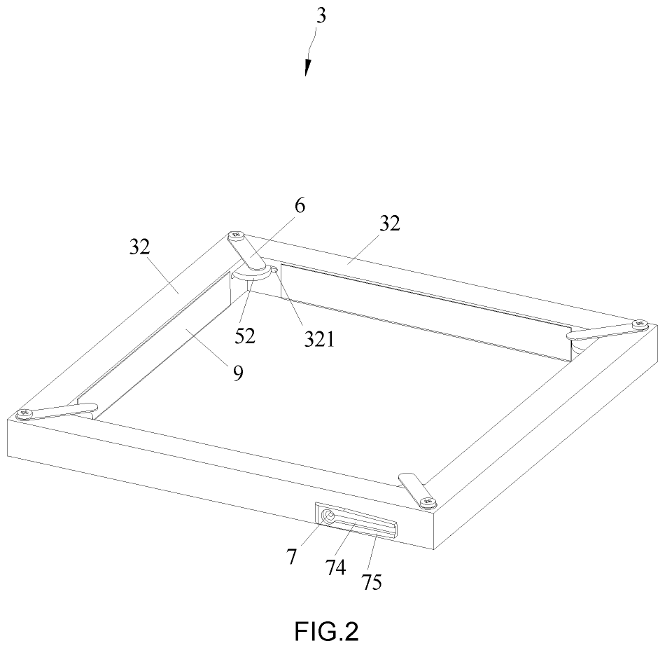

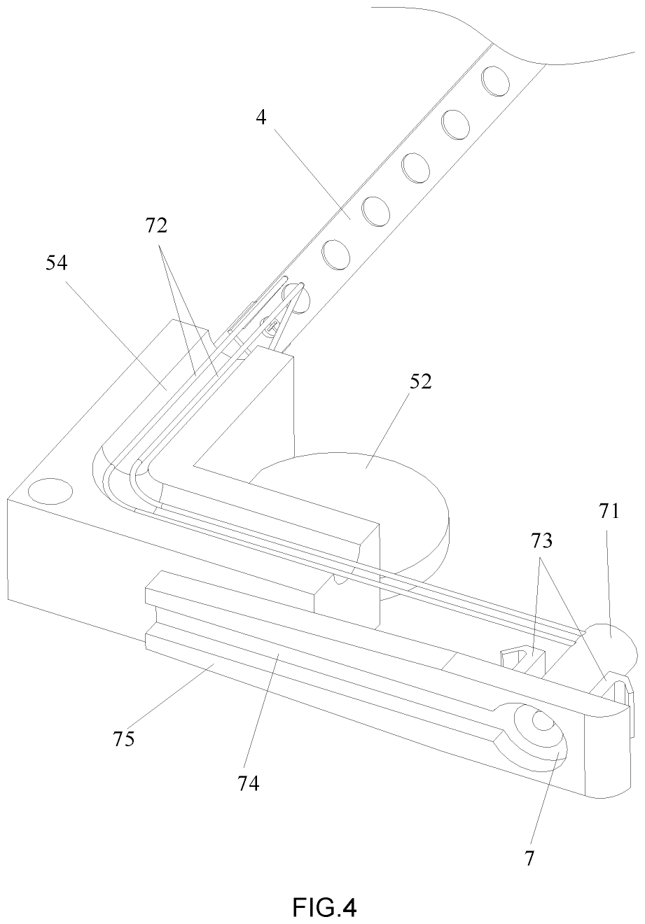

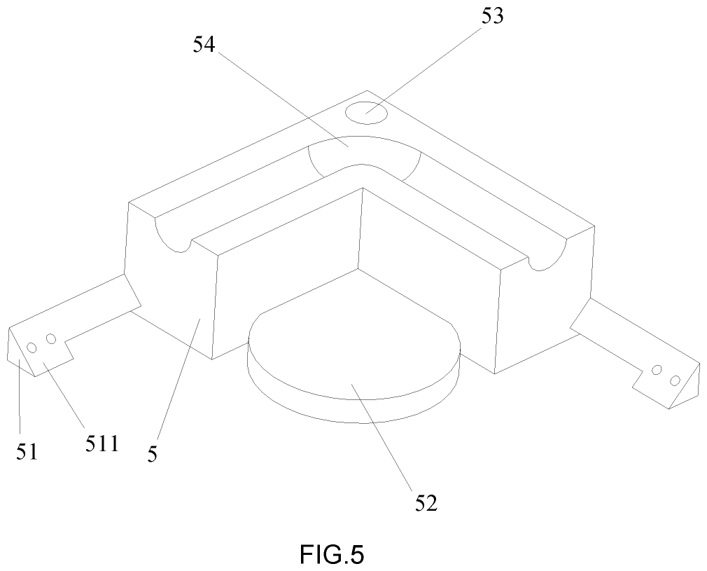

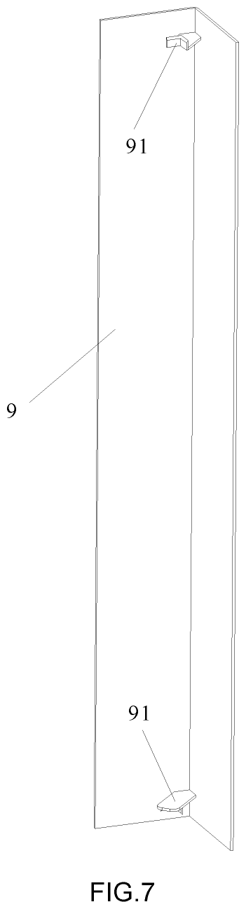

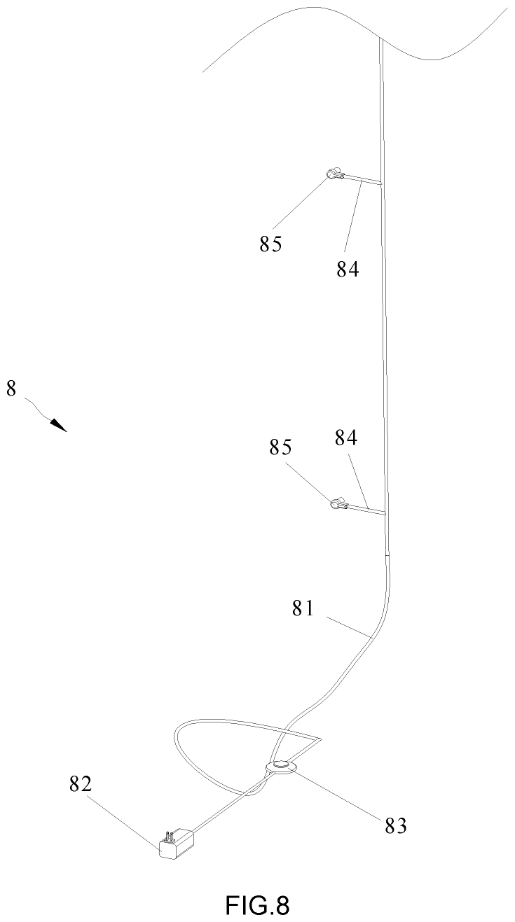

In an embodiment of the present utility model, as shown in FIG. 1 to FIG. 8, the shelf with lighting effect comprises a plurality of upright columns (1) and a plurality of mounting frames (3) with support plates (2), wherein the said mounting frames (3) are vertically spaced and connected respectively among the said upright columns (1), on the side of the said mounting frames (3) is arranged with at least one lamp groove (31), and in the lamp groove (31) is arranged with an LED light strip (4) electrically connected with the power supply subassembly.

A technical solution of the present utility model vertically spaces a plurality of mounting frames, connects them respectively among a plurality of upright columns; the said mounting frames are installed with support plates to form a vertical shelf with a plurality of compartments, each of which can be used to hold objects; on the side of the mounting frames is arranged with at least one lamp groove, and in the lamp groove is arranged with an LED light strip electrically connected with the power supply subassembly to provide lighting effect for the objects placed on the support plates; certainly, users also can choose not to place objects on the shelf but use the shelf as a lamp decoration. Compared with conventional shelves, the shelf in the present utility model is arranged with an LED light strip to provide lighting effect for the objects placed on the support plates and thus effectively prevent people from colliding with the shelf due to insufficient light when walking at night; meanwhile, the LED light strip can improve the decorative effect of the shelf; the overall structure of the shelf is simple and thus the installation and removal of the shelf is very convenient.

Concretely, the said mounting frames (3) are formed through the connection of a plurality of hollow tubular members (32) and enclose the said support plates (2); the said LED light strips (4) are fixedly installed in the tubular members (32); the internal positions of the mounting frames (3) corresponding to the LED light strips (4) are arranged with bar openings (33) connected with the interior of the tubular members (32) to form the lamp grooves for the LED light strips to radiate light.

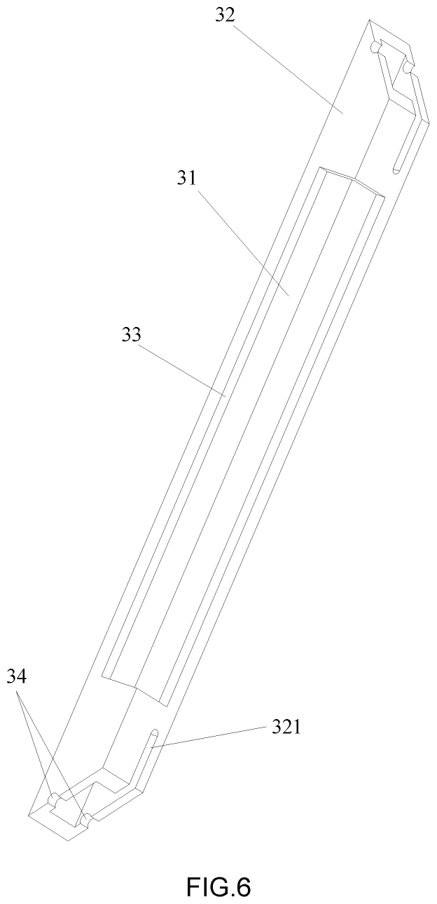

Concretely, the said bar openings (33) are arranged on any side wall among the upper, lower, left and right-side walls of each tubular member, or at the transitional position of two adjacent side walls among the upper, lower, left and right-side walls of each tubular member. In in this embodiment, as shown in FIG. 6, the said bar opening (33) is arranged at the transitional position of two adjacent side walls of the tubular member.

Concretely, the tubular members are polygonal, circular or in other shapes.

Concretely, in other embodiments, the tubular members (32) are solid structures. In this embodiment, the hollow interiors of the tubular members (32) are used as the lamp grooves (31) for installing the LED light strips; therefore, in this embodiment, it is allowed that every tubular member (32) is arranged with an LED light strip (4), or some tubular members (32) are arranged with LED light strips (4), and some other tubular members (32) are not provided with LED light strips (4).

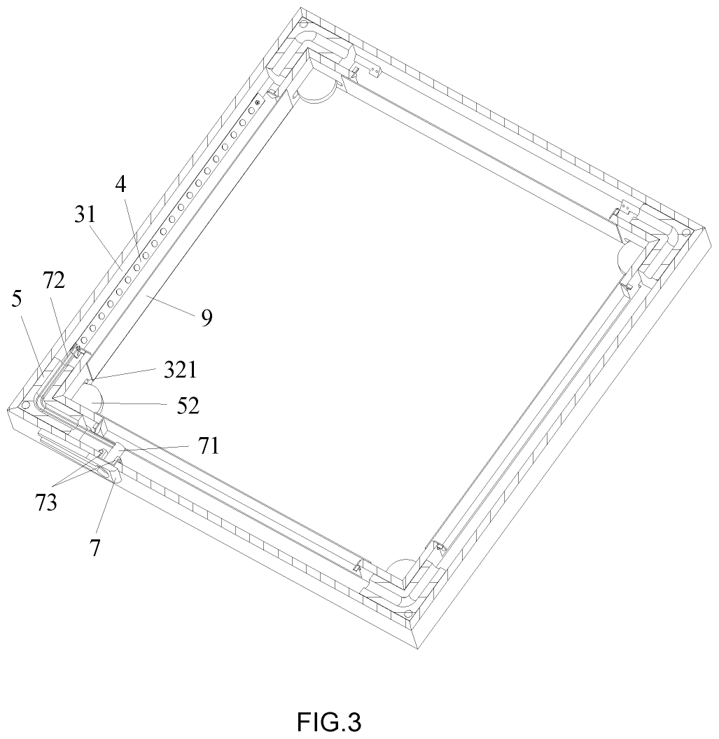

Concretely, as shown in FIG. 3, one of the tubular members (32) is arranged with an LED light strip (4) and a bar opening (33), the other tubular members (32) are not arranged with LED light strips (4).

Concretely, the said lamp grooves (31) can be arranged on the upper, inner or bottom side walls or at two adjacent side walls of the mounting frames (3); the said lamp grooves (31) can be also arranged on the outer side walls of the mounting frames (3), but the object lighting effect of the LED light strips is relatively poor.

Understandably, three or more tubular members (32) connected can form a frame structure; for example, if there are three tubular members (32), the mounting frame (3) will be a triangular structure; if there are four tubular members (32), the mounting frame (3) will be a quadrangular structure; if there are five tubular members (32), the mounting frame (3) will be a pentagon structure.

In other embodiments, the mounting frames (3) can be circular, elliptical or other polygonal frame structures. In this embodiment, the mounting frame (3) is a quadrangular structure consisting of four tubular members (32).

Certainly, it can be understood that in other embodiments, the mounting frames (3) can also comprise single tubular members (32), which are bent and connected end to end to form circular, elliptical or polygonal frame structures.

Concretely, in the tubular members (32) are arranged with mounting parts (51), and the ends of the said LED light strips (4) are bonded with glue or locked with screws onto the mounting parts (51).

Concretely, when the bar opening (33) is arranged on one side of the tubular member (32), the fitting surface between the mounting part (51) and the LED light strip (4) is a horizontal plane or a vertical plane; when the bar opening (33) is arranged at the transitional position of two adjacent sides of the tubular member (32), the fitting surface between the mounting part (51) and the LED light strip (4) is a slope (511) to maximize the lighting range of the LED light strip (4) and thus improve the lighting effect. In this embodiment, the fitting surface of the mounting part (51) with the LED light strip (4) is a slope (511).

Concretely, in the mounting frames (3) are arranged with a plurality of support parts (52) at intervals, and the upper walls of the support parts (52) can vertically abut the lower walls of the support plates (2) to support the support plates (2).

Concretely, the positions of the mounting frames (3) corresponding to the end walls of the upright columns (1) are arranged with first through apertures (34) that run through the top and bottom walls of the mounting frames (3), the end walls of the said upright columns (1) are arranged with plug-in parts (not shown in the accompanying drawings) that can be inserted into the first through apertures (34); after being inserted into the first through apertures (34), the plug-in parts (not shown in the accompanying drawings) can make the top walls of the upright columns (1) abut the bottom walls of the mounting frames (3) or make the bottom walls of the upright columns (1) abut the top walls of the mounting frames (3) to form the assembly of the upright columns (1) and the mounting frames (3).

Concretely, two adjacent tubular members (32) are connected and fixed via a corner block (5); the sides of the said corner blocks (5) adjoining the LED light strips (4) are extended with the mounting part (51); the positions of the said corner blocks (5) corresponding to the first through apertures are arranged with second through apertures (53) that run through the top and bottom walls of the corner blocks (5); the said plug-in parts (not shown in the accompanying drawings) can abut the second through apertures (53) after running through the first through apertures. in the mounting frames (3) corresponding to the ends of the tubular members (32) are arranged with third through apertures (321); the positions of the corner blocks (5) corresponding to the third through apertures (321) are arranged with the said support parts (52) that can run through the third through apertures (321); after two adjacent tubular members (32) are connected and fixed via the corner blocks (5), the said support parts (52) run through the said third through apertures (321) and are exposed in the mounting frames to support the support parts.

Concretely, the top wall of the uppermost mounting frame (5) is detachably fixed with locking pieces (6) via screws or buckle structures; the ends of the locking pieces (6) extend horizontally towards the inner side of the mounting frame (3) to abut the support plates vertically and thus prevent the support plates (2) from separating from the mounting frame (3).

Concretely, the support plates (2) are transparent or semi-transparent glass structures, or are transparent or semi-transparent plastic structures.

Concretely, the said power supply subassembly comprises a plurality of power bases (7) and a power cord (8); the said power bases (7) are fixedly mounted on the outer sides of the tubular members (32) and every power base (7) has a wire end (71) with a wire (72) wherein the wire end (71) can be extended into the tubular member (32), and the wire (72) is electrically connected with the LED light strip (4) after entering the tubular member (32); the said power cord (8) comprises a main cord body (81), a power plug (82) and a switch (83) electrically connected with the main cord body (81) as well as multiple sections of junction cords (84) extended from the main cord body (81), the number of junction cords (84) is the same as that of the power bases (7), the free end of every junction cord (84) is arranged with a power connector (85) adapted to the power base (7); after being electrically connected with the external power supply, the power plug (82) can be connected with a plurality of external power supplies via a plurality of power connectors (85) to form electrical connection to simultaneously supply power to the LED light strips in a plurality of mounting frames (3); the said switches (83) are used to control the power cord (8) to connect and disconnect from the external power supplies.

Concretely, the outer wall of the said power base (7) is arranged with a pair of first buckle members (73) that can be extended into the lamp groove (31) together with the wire end (71); after being fully extended into the lamp groove (31), the wire end (71) can lock the power base (7) via the first buckle members (73).

Concretely, the top wall of the said corner code (5) is arranged with a wire groove (54) for leading the wire (72) to the LED light strip (4), and the wire (72) is electrically connected with the LED light strip (4) after being leaded by the wire groove (54).

Concretely, the outer side of the exposed part of the said power base (7) is arranged with an extension part (75) extending horizontally towards the upright column (1), and after the said power connector (85) is inserted with the power base (7), the junction cord (84) can be wedged into the lead groove (74) so that the main cord body (81) is distributed outside the upright column (1).

Concretely, the position of the outer side of the mounting frame (3) corresponding to the bar opening (33) is arranged with a light transmitting cover (9); in the light transmitting cover (9) is arranged with a pair of second buckle members (91) that can be buckled with the inner wall of the tubular member and the light transmitting cover (9) can be buckled and fixed onto the mounting frame (3) via the said second buckle members (91) and thus seal the said bar opening (33).

Concretely, the said upright columns (1) and the mounting frames (3) are wood products or metal products.

Concretely, the cross section of the said upright column (1) is polygonal or circular.

Concretely, the corner block (5) and the tubular member (32) can be bonded and fixed with glue.

It should be noted that the matching of the tubular member (32) and the corner block (5) to form a frame structure belongs to the prior art, and thus its specific principle and structure are not described here.

The embodiments described above are merely the preferred embodiments of the present utility model, not to limit the patent scope of the present utility model; with the conception of the present utility model, any equivalent structure transformation using the Specifications and the accompanying drawings of the present utility model or direct/indirect applications to other related technical fields should be included in the scope claimed by the present utility model.

What is claimed is:

1. A shelf with lighting effect, which is characterized in that it comprises a plurality of upright columns (1) and a plurality of mounting frames (3) with support plates (2), wherein the said mounting frames (3) are vertically spaced and connected respectively among the said upright columns (1), on the side of the said mounting frames (3) is arranged with at least one lamp groove (31), and in the lamp grooves (31) are arranged with LED light strips (4) electrically connected with the power supply subassembly.

2. The shelf with lighting effect in accordance with claim 1, which is characterized in that the said mounting frames (3) are formed through the connection of a plurality of hollow tubular members (32) and enclose the said support plates (2); the said LED light strips (4) are fixedly installed in the tubular members (32); the positions of the mounting frames (3) corresponding to the LED light strips (4) are arranged with bar openings (33) connected with the interior of the tubular members (32) for the LED light strips to radiate light.

3. The shelf with lighting effect in accordance with claim 2, which is characterized in that the said bar openings (33) are arranged on any side wall among the upper, lower, left and right-side walls of each tubular member, or at the transitional position of two adjacent side walls among the upper, lower, left and right-side walls of each tubular member.

4. The shelf with lighting effect in accordance with claim 2, which is characterized in that in the tubular members (32) are arranged with mounting parts (51), the ends of the said LED light strips (4) are bonded with glue or locked with screws onto the mounting parts (51).

5. The shelf with lighting effect in accordance with claim 4, which is characterized in that in the mounting frames (3) are arranged with a plurality of support parts (52) at intervals, and the upper walls of the support parts (52) can vertically abut the lower walls of the support plates (2) to support the support plates (2).

6. The shelf with lighting effect in accordance with claim 5, which is characterized in that the positions of the mounting frames (3) corresponding to the end walls of the upright columns (1) are arranged with first through apertures (34) that run through the top and bottom walls of the mounting frames (3), the end walls of the said upright columns (1) are arranged with plug-in parts that can be inserted into the first through apertures (34); after being inserted into the first through apertures (34), the plug-in parts can make the top walls of the upright columns (1) abut the bottom walls of the mounting frames (3) or make the bottom walls of the upright columns (1) abut the top walls of the mounting frames (3) to form the assembly of the upright columns (1) and the mounting frames (3).

7. The shelf with lighting effect in accordance with claim 6, which is characterized in that two adjacent tubular members (32) are connected and fixed via a corner block (5); the sides of the said corner blocks (5) adjoining the LED light strips (4) are extended with the mounting part (51); the positions of the said corner blocks (5) corresponding to the first through apertures are arranged with second through apertures (53) that run through the top and bottom walls of the corner blocks (5); the said plug-in parts can abut the second through apertures (53) via the first through apertures; in the mounting frames (3) corresponding to the ends of the tubular members (32) are arranged with third through apertures (321); the positions of the corner blocks (5) corresponding to the third through apertures (321) are arranged with the said support parts (52) that can run through the third through apertures (321); after two adjacent tubular members (32) are connected and fixed via the corner blocks (5), the said support parts (52) run through the said third through apertures (321) and are exposed in the mounting frames to support the support parts.

8. The shelf with lighting effect in accordance with claim 1, which is characterized in that the top wall of the uppermost mounting frame (5) is detachably fixed with locking pieces (6) via screws or buckle structures; the ends of the locking pieces (6) extend horizontally towards the inner side of the mounting frame (3) to abut the support plates vertically and thus prevent the support plates (2) from separating from the mounting frame (3).

9. The shelf with lighting effect in accordance with claim 1, which is characterized in that the support plates (2) are light transmitting or semi-transmitting glass structures, or are light transmitting or semi-transmitting plastic structures.

10. The shelf with lighting effect in accordance with claim 7, which is characterized in that the said power supply subassembly comprises a plurality of power bases (7) and a power cord (8); the said power bases (7) are fixedly mounted on the outer sides of the tubular members (32) and every power base (7) has a wire end (71) with a wire (72) wherein the wire end (71) can be extended into the tubular member (32), and the wire (72) is electrically connected with the LED light strip (4) after entering the tubular member (32); the said power cord (8) comprises a main cord body (81), a power plug (82) and a switch (83) electrically connected with the main cord body (81) as well as multiple sections of junction cords (84) extended from the main cord body (81), the number of junction cords (84) is the same as that of the power bases (7), the free end of every junction cord (84) is arranged with a power connector (85) adapted to the power base (7); after being electrically connected with the external power supply, the power plug (82) can be connected with a plurality of external power supplies via a plurality of power connectors (85) to form electrical connection to simultaneously supply power to the LED light strips in a plurality of mounting frames (3); the said switches (83) are used to control the power cord (8) to connect and disconnect from the external power supplies.

11. The shelf with lighting effect in accordance with claim 10, which is characterized in that the outer wall of the said power base (7) is arranged with a pair of first buckle members (73) that can be extended into the lamp groove (31) together with the wire end (71); after being fully extended into the lamp groove (31), the wire end (71) can lock the power base (7) via the first buckle members (73).

12. The shelf with lighting effect in accordance with claim 10, which is characterized in that the top wall of the said corner code (5) is arranged with a wire groove (54) for leading the wire (72) to the LED light strip (4), and the wire (72) is electrically connected with the LED light strip (4) after being leaded by the wire groove (54).

13. The shelf with lighting effect in accordance with claim 10, which is characterized in that the outer side of the exposed part of the said power base (7) is arranged with an extension part (75) extending horizontally towards the upright column (1), and after the said power connector (85) is inserted with the power base (7), the junction cord (84) can be wedged into the lead groove (74) so that the main cord body (81) is distributed outside the upright column (1).

14. The shelf with lighting effect in accordance with claim 2, which is characterized in that the position of the outer side of the mounting frame (3) corresponding to the bar opening (33) is arranged with a light transmitting cover (9); in the light transmitting cover (9) is arranged with a pair of second buckle members (91) that can be buckled with the inner wall of the tubular member and the light transmitting cover (9) can be buckled and fixed onto the mounting frame (3) via the said second buckle members (91) and thus seal the said bar opening (33).
